(19) United States
(12) Patent Application Publication
(10) Pub. No.: US 2007/0032120 A1
(43) Pub. Date: Feb. 8, 2007

(54) Fuse guard ring for semiconductor device

(75) Inventors: In Gu Kim, Gyeonggi-do (KR); Kwang Ho Ahn, Gyeonggi-do (KR); Seong Sik Kim, Gyeonggi-do (KR)

Correspondence Address: HELLER EHRMAN WHITE & MCAULIFFE LLP, 1717 RHODE ISLAND AVE, NW, WASHINGTON, DC, 20036-3001, US

(73) Assignee: Hynix Semiconductor Inc., Gyeonggi-do (KR)

(21) Appl. No.: 11/321,625

(22) Filed: Dec. 30, 2005

(30) Foreign Application Priority Data
Aug. 5, 2005 (KR) 10-2005-0071748

(51) Int. Cl. H01R 13/627

(52) U.S. Cl. 439/365

(57) ABSTRACT

A semiconductor device is provided. A fuse guard ring is patterned to prevent a crack phenomenon generated in the fuse guard ring formed surrounding a fuse of the semiconductor device, thereby relieving stress applied to the fuse guard ring and preventing damage of the fuse to improve characteristics and reliability of the semiconductor device.

### BACKGROUND OF THE INVENTION

1. Field of the Invention

The present invention relates to a memory device. In particular, the present invention provides a fuse guard ring for a semiconductor device, and more specifically to a fuse guard ring for a semiconductor device wherein in order to prevent a crack at a fuse guard ring formed on a fuse of the semiconductor device, a fuse guard ring is designed as a plurality of patterns to relieve stress applied to the fuse guard ring and avoid damage to the fuse, thereby improving characteristics and reliability of the semiconductor device. Although the present invention has been applied to a specific memory device, there can be other applications.

2. Description of the Related Art

In general, a repair process comprises a pre-repair test, a repair test, and a post-repair test.

The pre-repair test is performed on a main cell that has failed by blowing a fuse in a fuse set for a redundancy cell so as to replace an address of the main cell having the fail.

FIG. 1 is a simplified cross-sectional view illustrating one fuse guard ring for a semiconductor device. FIGS. 2a through 2c are simplified layout views illustrating each of contact plugs in one fuse guard ring. FIG. 1 shows the complete fuse guard ring taken along the line A-A of FIG. 2c.

Referring to FIGS. 1 and 2a, two n-type impurity regions 13 are formed on a semiconductor substrate 11 having p-type silicon.

An interlayer insulating film (not shown) is formed on the entire surface to obtain a bit line contact plug 15 connected to the n-type impurity region 13.

Here, the bit line contact plug 15 is formed like a wall enclosing a fuse box region.

Referring to FIGS. 1 and 2b, a bit line 17 connected to the bit line contact plug 15 is formed.

The bit line 17 is formed to be perpendicular to the fuse region in the lower side of the fuse region. The bit line 17 is deposited on the bit line contact plug 15.

Next, an interlayer insulating film (not shown) is formed on the entire surface to obtain a first metal line contact plug 21 connected to the bit line 17 through the previously deposited interlayer insulating film.

The first metal line contact plug 21 is formed like a wall enclosing the fuse box region, and separated from the fuse 19 at a predetermined distance.

Referring to FIGS. 1 and 2c, a first metal line 23 is formed and connected to the first metal line contact plug 21. Here, the first metal line 23 is formed to be perpendicular to the fuse 19 in the upper side of the fuse 19, and deposited on the first metal line contact plug 21.

Next, an interlayer insulating film (not shown) is formed on the entire surface, and a second metal line contact plug 25 is formed and connected to the first metal line 23.

The second metal line contact plug 25 is formed like a wall enclosing the fuse box region.

Thereafter, a second metal line 27 is formed and connected to the second metal line contact plug 25. The fuse 19 passing through the fuse guard ring is located at the center of the fuse guard ring. The fuse guard ring is formed on opposing sides, which includes the bit line contact plug 15, the bit line 17, the first metal line contact plug 21, the first metal line 23, the second metal line contact plug 25 and the third metal line 27.

When the fuse 19 is cut with a laser, the fuse guard ring is formed from the top second metal line 27 to the bottom semiconductor substrate 11 in order to prevent the cut fuse 19 from penetrating moisture and damage of internal circuits due to stress.

The semiconductor device of FIG. 1 becomes open to operate as logic device when the cut portion of the fuse 19 is cut, whereas close when it is not cut.

In the above-described fuse guard ring, a crack is generated in the fuse guard ring by thermal treatment in the subsequent process. As a result, a fuse or its peripheral circuits may be damaged to cause a block fail or an IDD fail.

### SUMMARY OF THE INVENTION

According to the present invention, techniques for a memory device are provided. In particular, the present invention provides a fuse guard ring for a semiconductor device which comprises a bit line contact plug, a first metal line contact plug and a second metal line contact plug each in a shape like a plurality of walls or columns to prevent overall diffusion of stress, thereby preventing damage of the fuse guard ring. Although the present invention has been applied to a specific memory device, there can be other applications.

In order to achieve the above advantage, an embodiment of the present invention, a fuse guard ring for a semiconductor device, comprising:

a bit line contact plug disposed in a fuse guard ring region on a semiconductor substrate with at least two separate parts, a bit line connected to the bit line contact plug and located in the fuse guard ring region, a first metal line contact plug connected to the bit line and disposed in the fuse guard ring region with at least two separate parts, a first metal line connected to the first metal line contact plug, and located in the fuse guard ring region, a second metal line contact plug connected to the first metal line and disposed in the fuse guard ring region with at least two separate parts, and a second metal line connected to the second metal line contact plug and located in the fuse guard ring region

Preferably, the first metal line contact plug is spaced apart from a fuse disposed between the bit line and the first metal line by a predetermined distance.

Preferably, a ratio of the width of the bit line contact plug to the distance between the bit line contact plug and its neighboring contact plug; a ratio of the width of the first metal line contact plug to the distance between the first metal line contact plug and its neighboring contact plug; and a ratio of the width of the second metal line contact plug to the distance between the second metal line contact plug and its neighboring contact plug are respectively about 1:2.

In order to achieve the above advantage, another embodiment of the present invention, a fuse guard ring for a semiconductor device, comprising:

a hole-type bit line contact plug disposed in a fuse guard ring region on a semiconductor substrate with at least two separate parts, a bit line connected to the bit line contact plug and located in the fuse guard ring region, a hole-type first metal line contact plug connected to the bit line and disposed in the fuse guard ring region with at least two separate parts, a first metal line connected to the first metal line contact plug and located in fuse the guard ring region, a hole-type second metal line contact plug connected to the first metal line and disposed in the fuse guard ring region with at least two separate parts, and a second metal line connected to the second metal line contact plug and located in the fuse guard ring region.

Preferably, a ratio of the width of the bit line contact plug to the distance between the bit line contact plug and its neighboring bit line contact plug is about 1:2.

Preferably, the size of the bit line contact plug ranges from about 0.10×0.10 μm to about 0.30×0.30 μm.

Preferably, the distance between two neighboring bit line contact plugs ranges from about 0.20 μm to about 0.60 μm.

Preferably, the bit line contact plug has a space pattern in the corner of the fuse guard ring region.

Preferably, a ratio of the width of the first metal line contact plug to the distance between the first metal line contact plug and its neighboring first metal line contact plug is about 1:2.

Preferably, the size of the first metal line contact plug ranges from about 0.10×0.10 μm to about 0.30×0.30 μm.

Preferably, the distance between two neighboring first metal line contact plugs ranges from about 0.20 μm to about 0.60 μm.

Preferably, the first metal line contact plug is spaced apart from a fuse disposed between the bit line and the first metal line by a predetermined distance.

Preferably, the predetermined distance between the fuse and the first metal line contact plug ranges from about 0.2 μm to about 0.60 μm, and the distance between two neighboring fuses ranges from about 0.80 μm to about 2.40 μm.

Preferably, the first metal line contact plug has a space pattern in the corner of the fuse guard ring region.

Preferably, a ratio of the width of the second metal line contact plug to the distance between the second metal line contact plug and its neighboring second metal line contact plug is about 1:2.

Preferably, the size of the second metal line contact plug ranges from about 0.15×0.15 μm to about 0.45×0.45 μm.

Preferably, the distance between two neighboring second metal line contact plugs ranges from about 0.40 μm to about 0.80 μm.

Preferably, the second metal line contact plug has a space pattern in the corner of the fuse guard ring region.

### BRIEF DESCRIPTION OF THE-DRAWINGS

Other aspects and advantages of the present invention will become apparent upon reading the following detailed description and upon reference to the drawings in which:

FIG. 1 is a simplified cross-sectional view illustrating one fuse guard ring for a semiconductor device;

FIGS. 2a through 2c are simplified layout views illustrating each of contact plugs in one fuse guard ring;

FIGS. 3 through 5 are views illustrating a fuse guard ring according to a first embodiment of the present invention; and

FIG. 6 is views illustrating a fuse guard ring according to a second embodiment of the present invention.

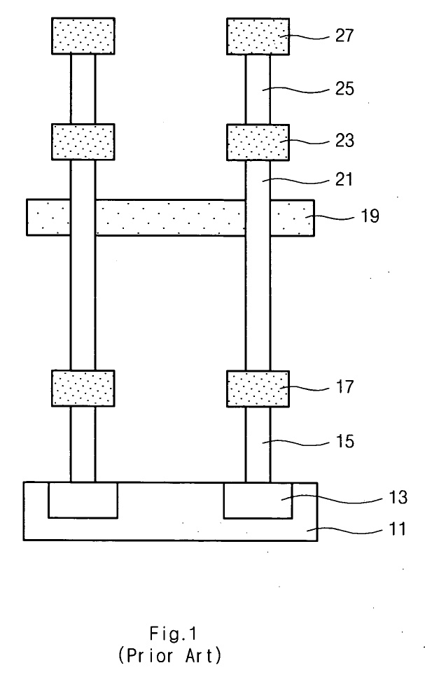

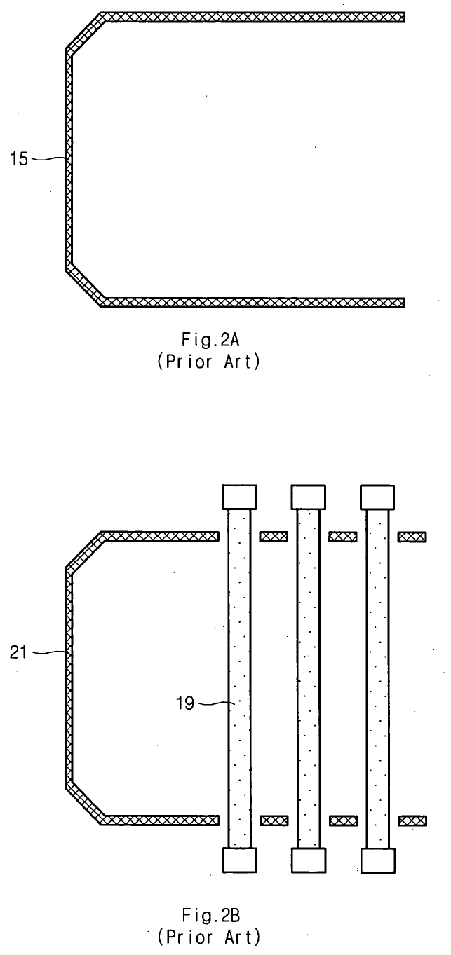

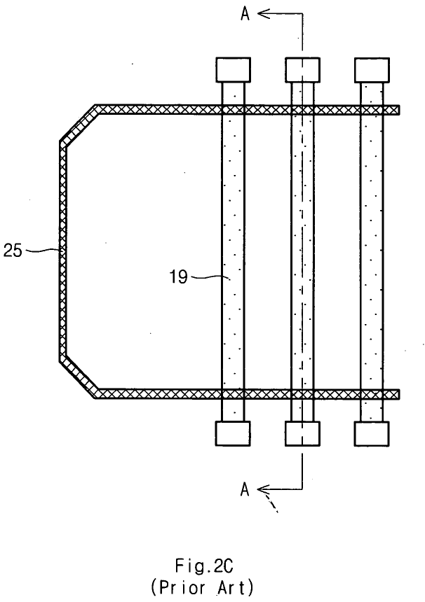

### DETAILED DESCRIPTION OF THE EXEMPLARY EMBODIMENTS

Reference will now be made in detail to exemplary embodiments of the present invention. Wherever possible, the same reference numbers will be used throughout the drawings to refer to the same or like parts. It should be appreciated that the embodiments are provided for the purpose that one ordinarily skilled in the art would be able to understand the present invention, and modifications in various manners and the scope of the present invention are not limited by the embodiments described herein.

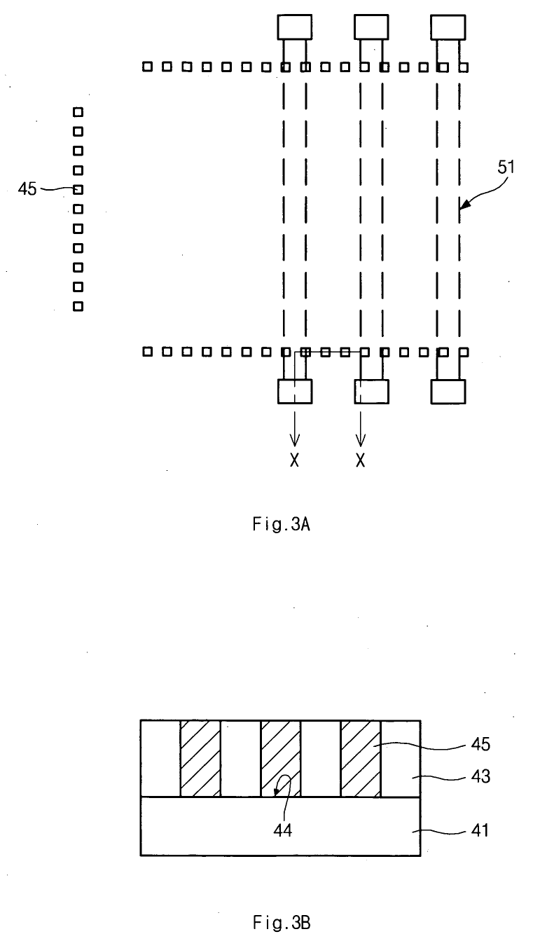

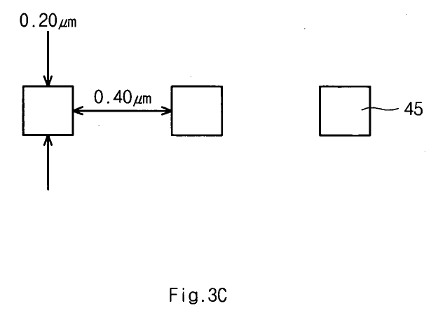

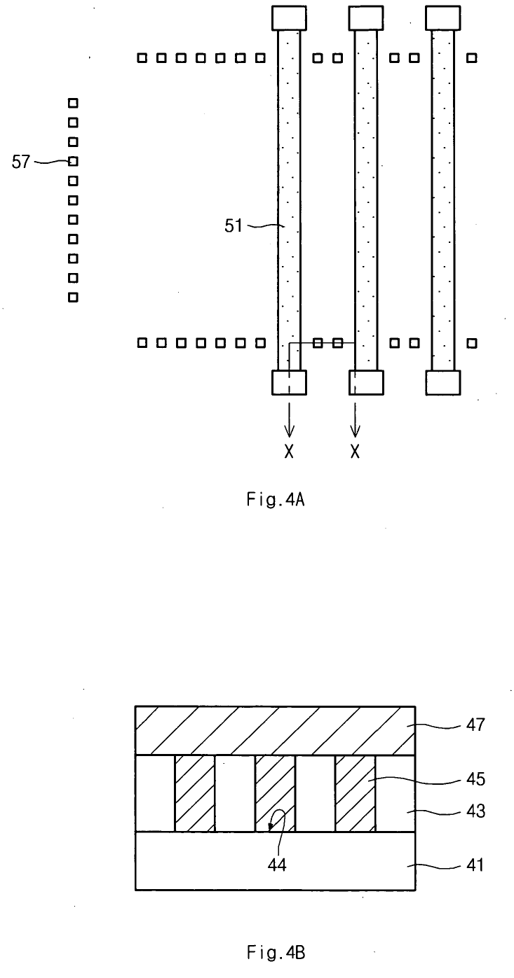

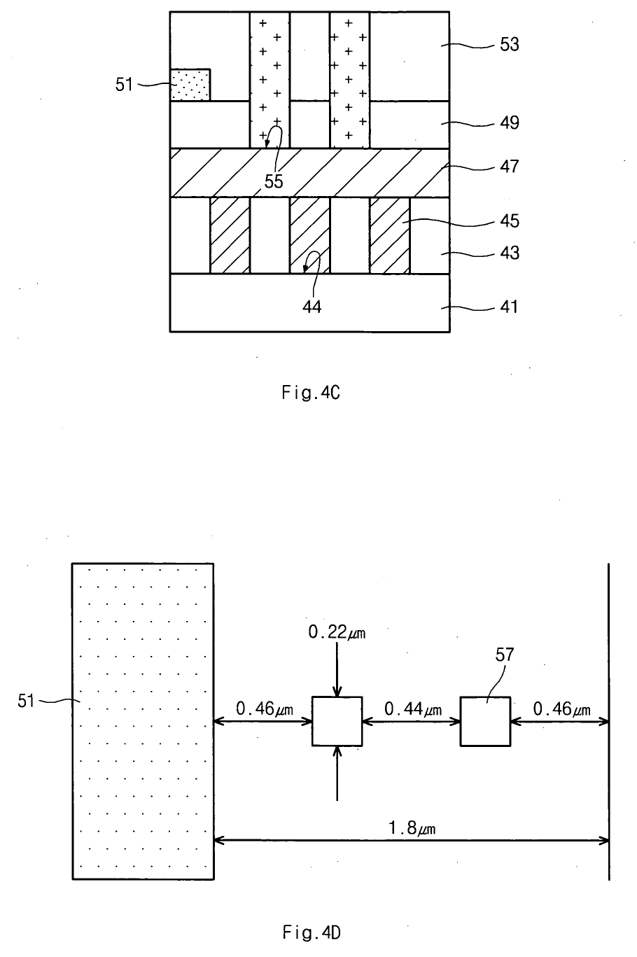

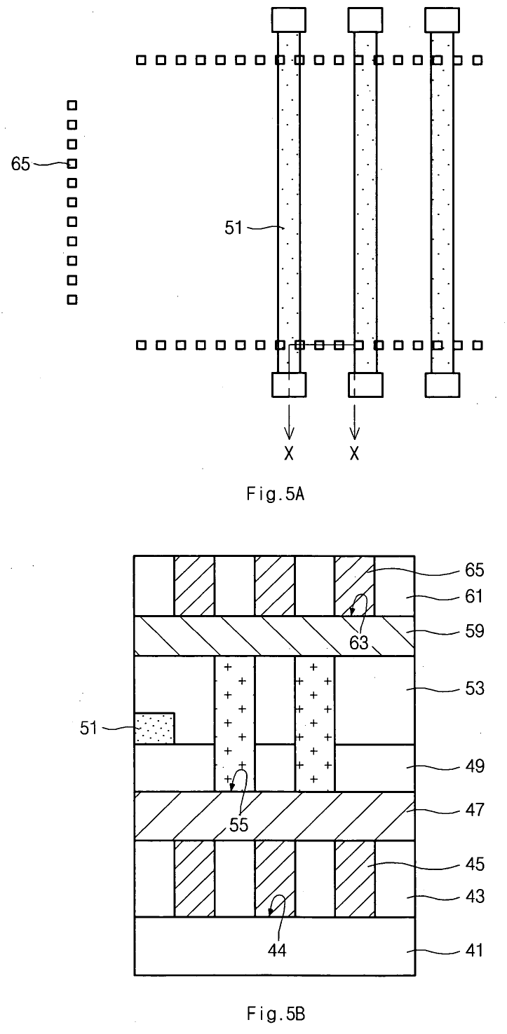

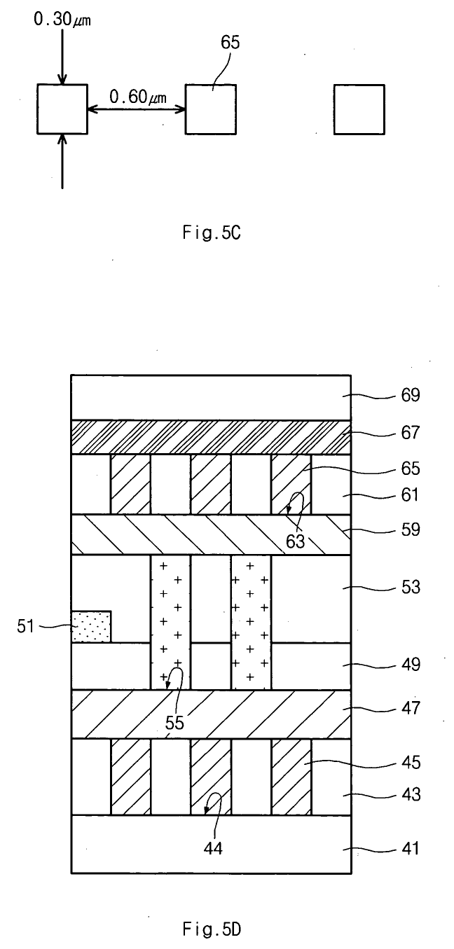

FIGS. 3 through 5 are views illustrating a fuse guard ring according to a first embodiment of the present invention. FIGS. 3a, 4a and 5a show a hole-type bit line contact plug, a first metal line contact plug and a second metal line contact plug. FIG. 3b is a cross-sectional view taken along the line X-X of FIG. 3a; FIGS. 4b and 4c are respectively cross-sectional views taken along the line X-X of FIG. 4a; and 5b and 5d are cross-sectional views taken along the line X-X of FIGS. 5a. FIGS. 3c, 4c and 5c are views illustrating the distance between two neighboring contact plugs of FIGS. 3a, 4a, and 5a, respectively.

Referring to FIGS. 3a through 3c, an interlayer insulating film 43 having a gate (not shown) formed on a semiconductor substrate 41 is formed.

The interlayer insulating film 43 is etched to form a bit line contact hole 44 exposing the semiconductor substrate 41, and a bit line contact plug 45 for filling the contact hole 44 is formed.

Here, a ratio of the width of the bit line contact plug 45 to the distance between the bit line contact plug and its neighboring contact plug 45 is about 1:2. For example, a width of the bit line contact plug 45 preferably ranges from about 0.10 μm to about 0.30 μm, more preferably about 0.20 μm. In addition, a distance between two neighboring bit line contact plugs 45 ranges from about 0.20 μm to about 0.60 μm, more preferably about 0.40 μm.

The dotted line of FIG. 3a shows a fuse region formed in a subsequent process.

Referring to FIGS. 4a through 4d, a bit line conductive layer (not shown) connected to the bit line contact plug 45 is formed on the entire surface of the resultant structure, and then patterned to form a bit line 47.

Next, an interlayer insulating film 49 is formed on the entire surface including the bit line 47, and then a fuse 51 is patterned on the interlayer insulating film 49.

An interlayer insulating film 53 is formed on the entire surface including the fuse 51. The interlayer insulating films 53 and 49 are etched via a photolithography method using a first metal line contact mask (not shown) to form a first metal line contact hole 55 exposing the bit line 47.

The first metal line contact plug 57 connected to the bit line 47 is formed by filling up the first metal line contact hole 55.

A ratio of the width of the first metal line contact plug 57 to the distance between the first metal line contact plugs 57 and its neighboring contact hole is about 1:2. For example, a width of the first metal line contact plug 57 ranges from about 0.10 μm to about 0.30 μm, more preferably about 0.22 μm. In addition, a distance of two neighboring first metal line contact plugs 57 ranges about 0.20 μm to about 0.60 μm, more preferably about 0.44 μm. Here, a distance between two neighboring fuses preferably ranges from about 0.8 μm to about 2.4 μm, more preferably about 1.8 μm. Moreover, a distance between the fuse 51 and the first metal line contact plug 57 preferably ranges from about 0.20 μm to about 0.60 μm, more preferably about 0.46 μm.

Referring to FIGS. 5a through 5d, a first metal line conductive layer (not shown) connected to the first metal line contact plug 57 is formed on the entire surface of the resultant structure.

Next, the first metal line conductive layer is patterned via an etching process using the first metal line mask (not shown) to form a first metal line 59, and an interlayer insulating film 61 is then formed on the entire surface.

The interlayer insulating film 61 is etched by an etching process using a second metal line contact mask (not shown) to form a second metal line contact hole 63 exposing the first meal line 59. Thereafter, a second metal line contact plug 65 connected to the first metal line 59 is formed by filling up the second metal line contact hole 63.

A ratio of the width of the second metal line contact plug 65 to the distance between the second metal line contact plug and its neighboring contact plug 65 is about 1:2. For example, a width of second metal line contact plug 65 ranges from about 0.15 μm to about 0.45 μm, more preferably about 0.30 μm. In addition, a distance between two second metal line contact plugs 65 ranges from about 0.40 μm to about 0.80 μm, more preferably about 0.60 μm.

Next, an interlayer insulating film 69 is formed on the entire surface of the resultant structure. Next, the interlayer insulating film 49 having a predetermined thickness remains, and the interlayer insulating films 61, 53 and 49 are etched to form a fuse box.

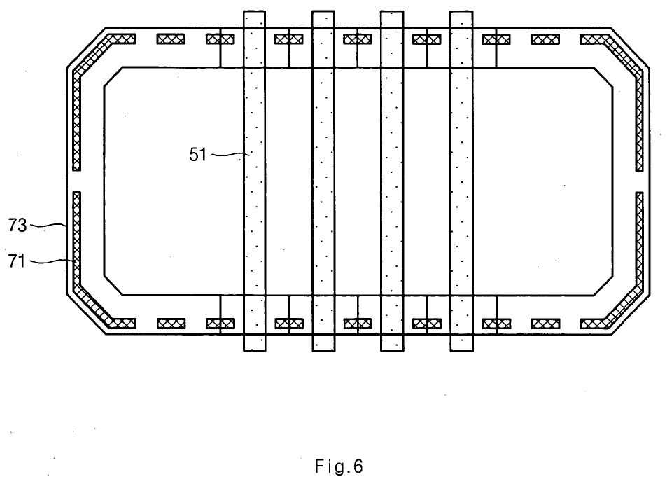

FIG. 6 is a plane view illustrating a fuse guard ring for a semiconductor device according to a second embodiment of the present invention, and shows a first metal line contact plug 71 of the fuse guard region of FIG. 4a and a first metal line 73 connected to the first metal line contact plug 71.

Here, the first metal line contact plug 71 comprises at least two separate space patterns in the fuse guard ring region to diffuse stress due to a thermal treatment process.

In such a structure, the first metal line contact plug 71 may be applied to the bit line contact plug (as the bit line contact plug 45 of the first embodiment) and the second metal line contact plug (as the second metal line contact 67 of the first embodiment).

As described above, in a fuse guard ring according to an embodiment of the present invention, when a contact plug used as a guard ring like an all-in-one wall to prevent crack generated from stress due to a thermal treatment process is comprised, the all-in-one contact plug is divided into at least two parts to relieve stress and prevent degradation of characteristics of other devices, thereby improving characteristics and reliability of a semiconductor device and facilitating high-integration of the semiconductor device.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A fuse guard ring for a semiconductor device, comprising:
a bit line contact plug disposed in a fuse guard ring region on a semiconductor substrate;
a bit line connected to the bit line contact plug and located in the fuse guard ring region;
a first metal line contact plug connected to the bit line and disposed in the fuse guard ring region;
a first metal line connected to the first metal line contact plug and located in the fuse guard ring region;
a second metal line contact plug connected to the first metal line and disposed in the fuse guard ring region; and
a second metal line connected to the second metal line contact plug and located in the fuse guard ring region.

2. The fuse guard ring according to claim 1, wherein the first metal line contact plug is spaced apart from a fuse disposed between the bit line and the first metal line by a predetermined distance.

3. The fuse guard ring according to claim 1, wherein a ratio of a first width of the bit line contact plug to a first distance between the bit line contact plug and its neighboring bit line contact plug; a ratio of a second width of the first metal line contact plug to a second distance between the first metal line contact and its neighboring first metal line contact plug; and a ratio of a third width of the second metal line contact plug to a third distance between the second metal line contact plug and its neighboring second metal line contact plug are each respectively about 1:2.

4. A fuse guard ring for a semiconductor device, comprising:
a hole-type bit line contact plug disposed in a fuse guard ring region on a semiconductor substrate;
a bit line connected to the bit line contact plug and located in the fuse guard ring region;
a hole-type first metal line contact plug connected to the bit line and disposed in the fuse guard ring region;
a first metal line connected to the first metal line contact plug and located in fuse the guard ring region;
a hole-type second metal line contact plug connected to the first metal line and disposed in the fuse guard ring region; and
a second metal line connected to the second metal line contact plug and located in the fuse guard ring region.

5. The fuse guard ring according to claim 4, wherein a ratio of a width of the bit line contact plug to a distance between the bit line contact plug and its neighboring bit line contact plug is about 1:2.

6. The fuse guard ring according to claim 4, wherein a size of the bit line contact plug ranges from about 0.10×0.10 μm to about 0.30×0.30 μm.

7. The fuse guard ring according to claim 4, wherein a distance between two neighboring bit line contact plugs ranges from about 0.20 μm to about 0.60 μm.

8. The fuse guard ring to claim 4, wherein the bit line contact plug has a space pattern in a corner of the fuse guard ring region.

9. The fuse guard ring according to claim 4, wherein a ratio of a width of the first metal line contact plug to a distance between the first metal line contact plug and its neighboring first metal line contact plug is about 1:2.

10. The fuse guard ring according to claim 4, wherein the a of the first metal line contact plug ranges from about 0.1×0.1 μm to about 0.3×0.3 μm.

11. The fuse guard ring according to claim 4, wherein a distance between two neighboring first metal line contact plugs ranges from about 0.20 μm to about 0.60 μm.

12. The fuse guard ring according to claim 4, wherein the first metal line contact plug is spaced apart from a fuse disposed between the bit line and the first metal line by a predetermined distance.

13. The fuse guard ring according to claim 12, wherein the predetermined distance between the fuse and the first metal line contact plug ranges from about 0.20 μm to about 0.60 μm, and a distance between two neighboring fuses ranges from about 0.8 μm to about 2.4 μm.

14. The fuse guard ring according to claim 4, wherein the first metal line contact plug has space pattern in a corner of the fuse guard ring region.

15. The fuse guard ring according to claim 4, wherein a ratio of a width of the second metal line contact plug to a distance between the second metal line contact plug and its neighboring second metal line contact plug is about 1:2.

16. The fuse guard ring according to claim 4, wherein the size of the second metal line contact plug ranges from about 0.15×0.15 μm to about 0.45×0.45 μm.

17. The fuse guard ring according to claim 4, wherein a distance between two neighboring second metal line contact plugs ranges from about 0.40 μm to about 0.80 μm.

18. The fuse guard ring according to claim 4, wherein the second metal line contact plug has space pattern in a corner of the fuse guard ring region.
